(19) United States
(12) Patent Application Publication
(10) Pub. No.: US 2002/0050201 A1
(43) Pub. Date: May 2, 2002

(54) TABLE SAW

(76) Inventors: WILLIAM LANE, BROOKLIN (CA); JOHN BARTLETT, PICKERING (CA); JOHN LABALLISTER, MORKHEM (CA); JAMES HILLIARD, MARKHAM (CA); WILLIAM DICKE, GRAFTON (CA); KEITH SCHOENE, ST. CHARLES, MO (US); DANIEL TERPSTRA, KIRKWOOD, MO (US)

Correspondence Address: ARNOLD WHITE & DURKEE, P O BOX 4433, HOUSTON, TX, 772104433

(21) Appl. No.: 09/416,210

(22) Filed: Oct. 8, 1999

Related U.S. Application Data
(62) Division of application No. 08/853,781, filed on May 9, 1997, now abandoned.

(51) Int. Cl. B26D 7/01; B27B 5/38; B27B 27/02; B27B 27/08; B27B 27/10

(52) U.S. Cl. 83/477.2; 83/473; 83/477; 83/468; 83/468.3; 83/468.7

(57) ABSTRACT

An improved table saw including: (1) an improved fence assembly having a handle cam rotatably mounted and received by at least one annular bearing; (2) a pivot pin to absorb shear loading that occurs when operator aligns fence channel perpendicular to fence head; (3) a grooved surface on the head assembly to substantially self-align the fence assembly parallel to the saw blade; (4) an improved microadjust assembly; (5) an improved locking pawl; (5) an improved miter gauge, and (6) a hinged belt guard.

### BACKGROUND OF THE INVENTION

The present invention relates to an improved saw. More particularly, the present invention relates to an improved table saw.

Table saws have a rotating saw blade extending through their upper surface for cutting workpieces positioned on the upper surface of the table saw. Typically, table saws are used for cross cutting (transverse cutting to the length of the workpiece), bevel cutting (at an angle to the length of the workpiece), and rip cutting (longitudinal along the length of the workpiece). For cross cutting and bevel cutting, an angularly and laterally adjustable fixture or fence is used, whereas for rip cutting, a separate rip fence must be to used to hold the workpiece in the desired position for the longitudinal or rip cutting that is to be performed.

Prior art table saw designs have several disadvantages. The locking lever assembly for the fence of some prior art table saw designs are a three piece sheet metal and die cast assembly. The wear plate and cam arrangement of these prior art designs can wear prematurely.

Another disadvantage of prior art table saws is the method of aligning the fence channel parallel to the blade. In some prior art table saws, the fence channel is fastened to the head by two adjustment screws in oversized holes. The oversized holes in the channel allows the channel to move relative to the head. However, in most of these prior art table saws, the fence is preferably locked prior to the tightening of the adjustment screws. The locking of the fence can bind the adjustment screws against the oversized holes and, thus, prevent the full range of adjustment. As a result, the benefit of the oversized holes is thereby lost.

Many prior art table saws do not have fences that can be lifted off the table at any given location. Moreover, the head of the fence assembly of most, if not all, prior art table saws binds against the rails of the saw as the fence is relocated. The binding of the fence assembly head with the rail causes the fence to misalign and causes excessive wear.

The microadjust assembly for the fence of most prior art table saws consists of a gear that engages a toothed rack. This assembly requires stamped metal pieces to be precisely mounted and matched to a rail and, thus, is expensive. Moreover, this type of assembly requires manual adjustment. Additionally, the fence assemblies of many prior art table saws have a two-piece roller glide and locking pawl that is difficult to move and more apt to have excessive wear due to the multiple parts.

Other prior art table saws have miter gauges that do not have convenient engagement pins and that do not provide sufficiently positive adjustment capabilities. Also, some prior art table saws have belt guards that require the operator to completely remove the belt guard prior to removing the belt from the pulley.

### SUMMARY OF THE INVENTION

The table saw of the present invention includes an improved fence assembly to overcome several of the above-mentioned disadvantages of the prior art table saws. For instance, the fence assembly of the present invention has a one-piece locking assembly. The operation (locking) of the one-piece assembly of the present invention is primarily accomplished by a one-piece injection-molded plastic handle and cam. In addition, the wear plate is not a separate part; rather, it is die cast as part of the fence head. Also, ball bearings provide the wear surfaces, rather than wear plates. Consequently, this improved locking assembly allows for a smoother action and longer life over previous designs.

The fence assembly of the present invention also provides for a pivot pin that extends from the fence head and engages a socket in the channel assembly (alternatively, the pivot pin can extend from the channel assembly and engage in a socket in the head). In either embodiment, the pin provides two important functions: (1) it provides a pivot point for adjustment, and (2) it absorbs shear load that occurs when the fence is locked, thereby allowing the operator to lock the fence in precise alignment without eliminating the clearance between the adjustment screws and their respective adjustment holes. As a result, this structural configuration allows the fence to be locked while forcing the head firmly against the front of the rail, thus allowing both the fence and head to be in precise alignment without binding the adjustment screws before they are tightened. Consequently, this arrangement allows the operator to tighten the adjustment screws to secure alignment of the head to the channel without moving (and thus misaligning) either the channel or head during tightening.

The fence assembly of the present invention also combines a self-aligning capability with a lift-off feature. The self-aligning feature is accomplished by a rail groove in the bottom of the head assembly that has a radius that matches the radius of a “knob” portion of the front saw rail.

The fence assembly of the present invention also includes an improved microadjust assembly that comprises a spring-loaded rubber tip with a knob handle. The operator pushes the knob handle to engage the rubber tip to the underside of the front rail. The operator then turns the knob handle causing the rubber tip to rotate, which in turn, moves the head and rail assembly along the front and rear table rails. The fence assembly of the present invention also includes a one-piece locking pawl and glide that engages the rear saw rail. The improved one-piece design uses a low friction surface for a smooth and easy relocation of the fence assembly.

Another aspect of the present invention is an improved miter gauge design that allows for a more positive adjustment than prior miter gauges. The improved adjustment is accomplished through the combination of an easy-to-use index pin and adjustment screws.

Another aspect of the present invention is a hinged belt guard which allows the operator to remove a belt from a pulley without having to completely remove the belt guard.

### BRIEF DESCRIPTION OF THE DRAWINGS

FIG. 1 is a front view of the preferred embodiment of the table saw of the present invention.

FIG. 2 is a side view of the preferred embodiment of the table saw of the present invention.

FIG. 3 is a perspective view of the preferred embodiment of the fence assembly of the table saw of the present invention.

FIG. 4 is a cross-sectional view of the preferred embodiment of the fence assembly of the table saw of the present invention.

FIG. 5 is a side view of the preferred embodiment of the fence assembly of the table saw of the present invention.

FIG. 6 is a top view of the preferred embodiment of the fence assembly of the table saw of the present invention.

FIG. 7 is an end view of the preferred embodiment of the fence assembly of the table saw of the present invention.

FIG. 8 is a perspective view of the preferred embodiment of the miter gauge of the table saw of the present invention.

FIG. 9 is a side view of the preferred embodiment of the miter gauge of the table saw of the present invention.

FIG. 10 is a top view of the preferred embodiment of the miter gauge of the table saw of the present invention.

FIG. 11 shows the hinged belt guard in the closed position.

FIG. 12 shows the hinged belt guard in the open position.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives following within the spirit and scope of the invention as defined by the appended claims.

### DESCRIPTION OF ILLUSTRATIVE EMBODIMENTS

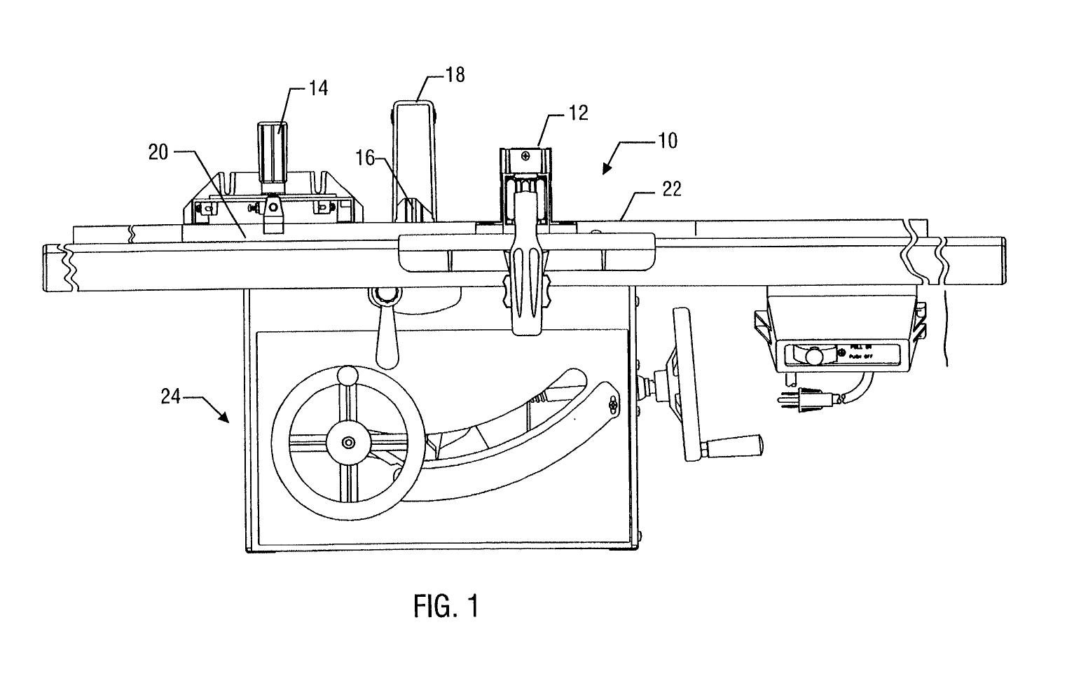

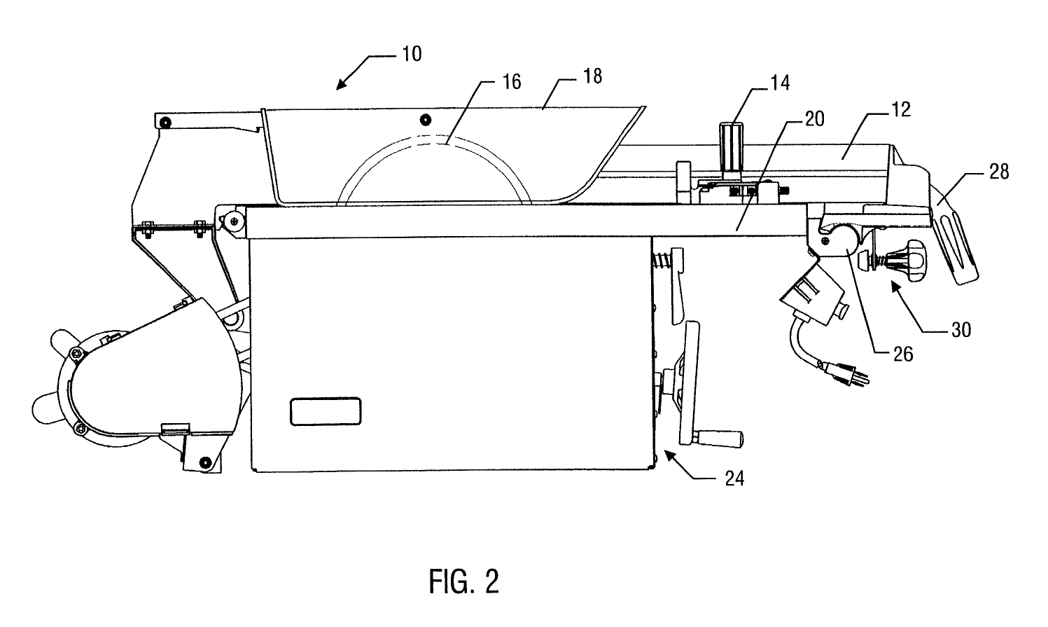

The present invention is an improved table saw. FIG. 1 is a front view of the preferred embodiment of the table saw 10 of the present invention. Table saw 10 includes fence assembly 12 and miter gauge assembly 14. Table saw 10 also includes a saw blade 16 with a guard 18, a table 20 with an upper surface 22, a base 24 and a front rail 26. FIG. 2 is a side view of the preferred embodiment of the table saw 10 of the present invention. FIG. 2 also shows handle cam 28 and microadjust assembly 30 of the preferred embodiment of fence assembly 12 of table saw 10 of the present invention.

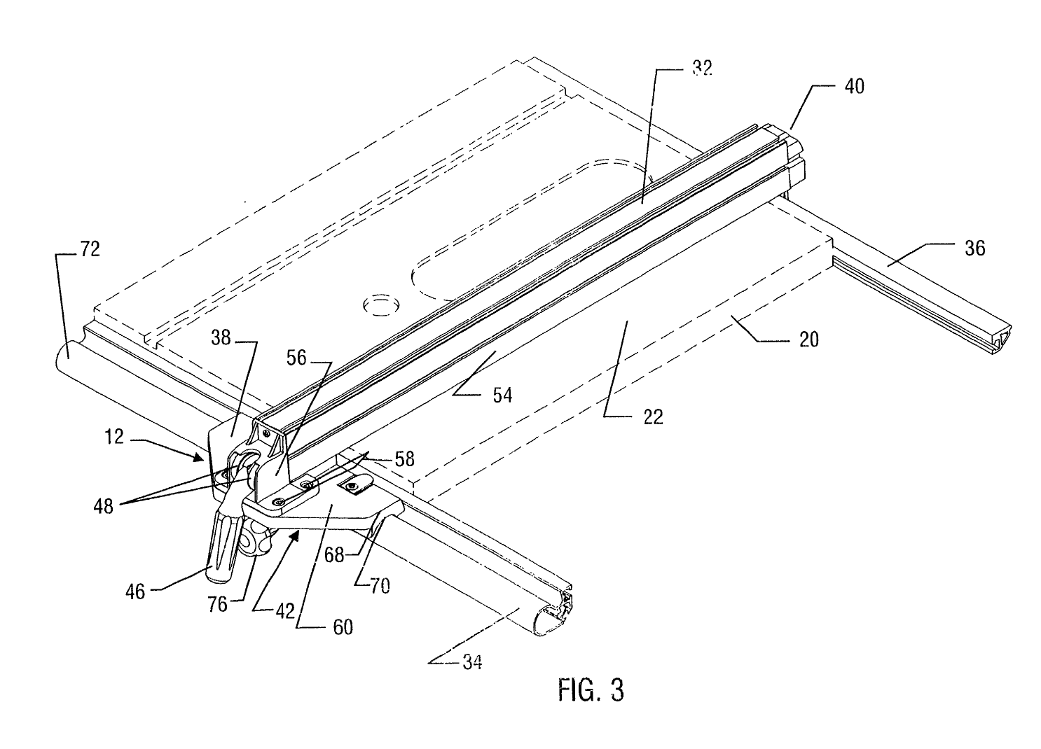

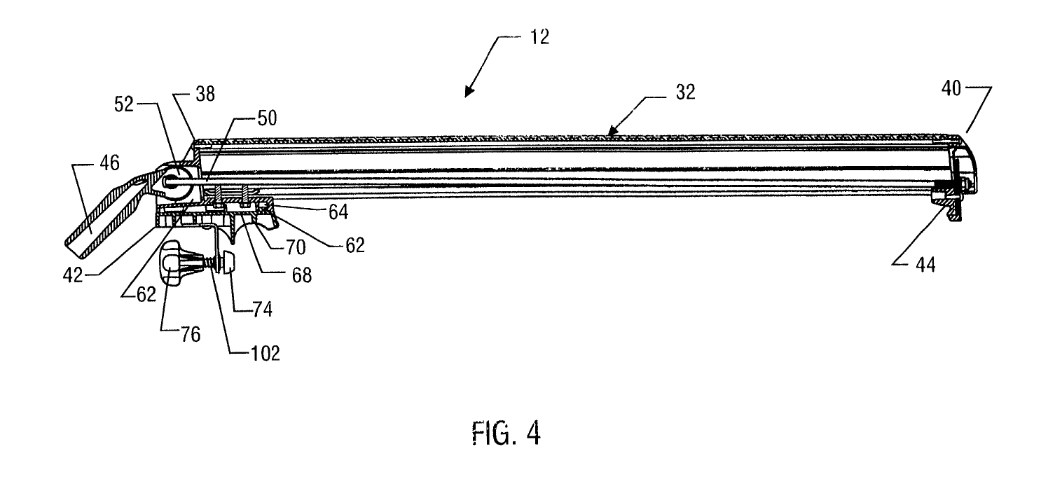

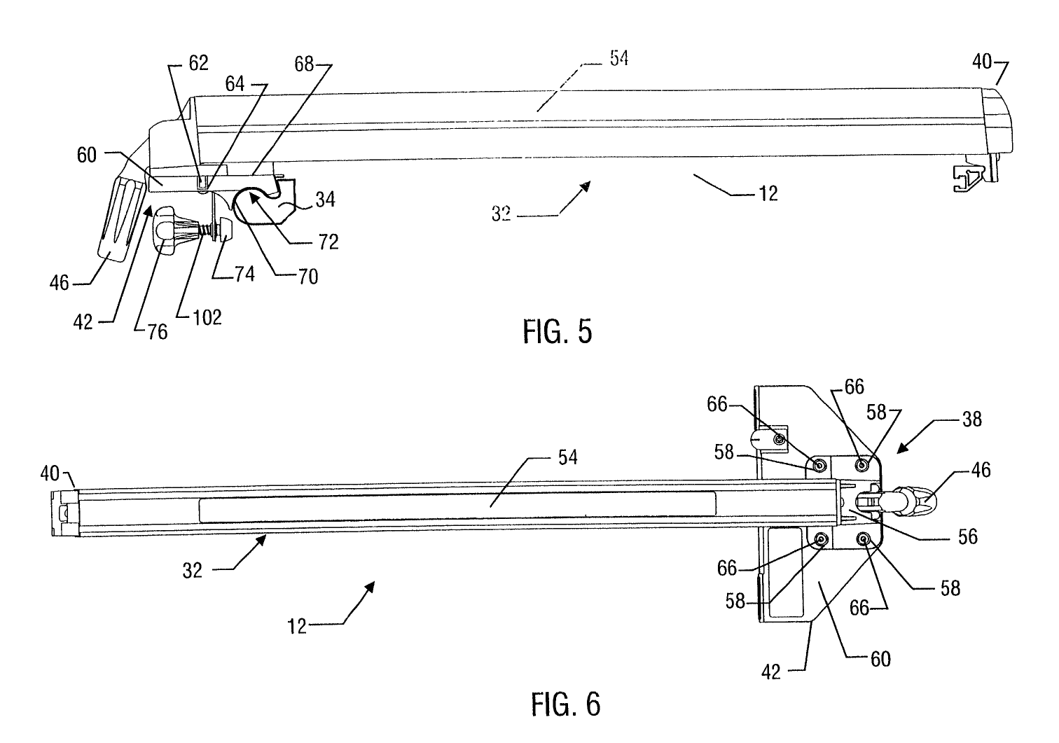

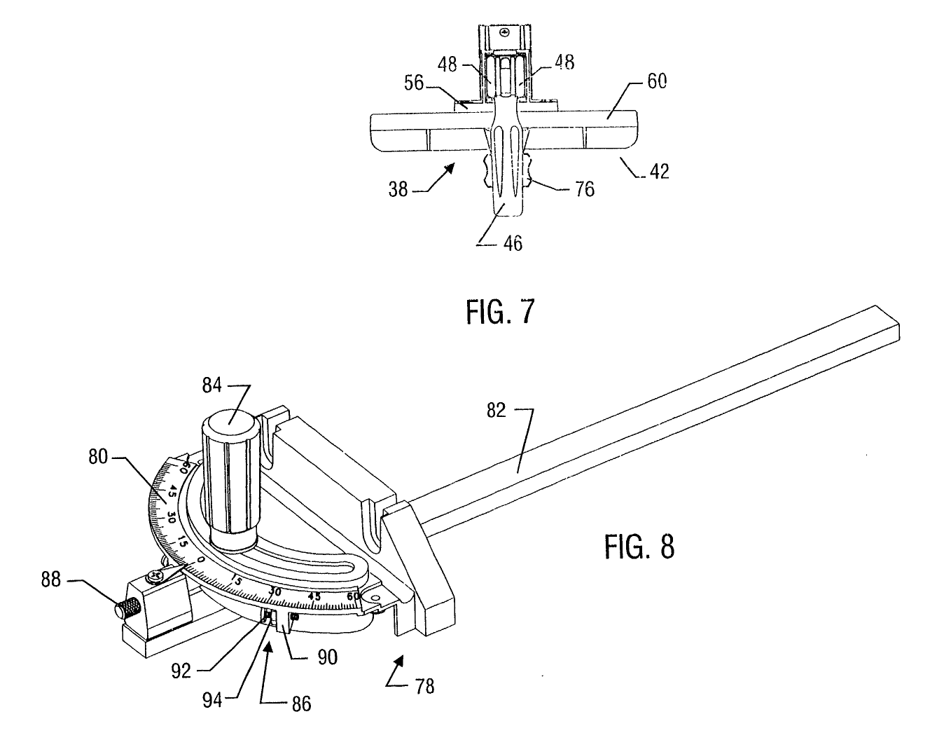

FIG. 3 is a perspective view of the preferred embodiment of fence assembly 12 of the present invention. Fence assembly 12 provides alignment for the cutting of a workpiece on table saw 10. Fence assembly 12 includes a fence channel assembly 32 which extends substantially across the upper surface 22 of table 20. Fence assembly 12 is slidably engaged with front rail 34 and rear rail 36. Fence assembly 12 includes a first end 38 and a second end 40. First end 38 of fence assembly 12 further includes a head assembly 42. Fence assembly 12 is shown in cross-sectional view in FIG. 4 and in side, top and end view in FIGS. 5, 6 and 7, respectfully. Fence assembly 12 further includes locking pawl 44 proximate second end 40 of fence channel assembly 32. The head assembly 42 includes a handle cam 46 for engaging locking pawl 44 such that locking pawl 44 applies a clamping pressure on rear rail 36. The clamping pressure applied by locking pawl 44 into rear rail 36 maintains fence assembly 12 in a stationary position. Handle cam 46 is rotatably mounted to fence channel assembly 32 by at least one annular bearing 48. Preferably, two annular bearings 48 rotatably receive and operatively mount handle cam 46 to fence channel assembly 32. Handle cam 46 is preferably constructed out of a single piece of material such as injection-molded plastic. However, handle cam 46 can be constructed out of more than one material and can be formed into many different shapes.

Handle cam 46 is operatively connected to the first end of rod fence lock 50. The second end of rod fence lock 50 is operatively connected to locking pawl 44. Locking pawl 44 is preferably constructed of a single material and slidably engages rear rail 36. However, locking pawl 44 can be constructed out of more than one material and can be formed into many different shapes.

Fence assembly 12 is locked into position on upper surface 22 of table 20 for a predetermined distance from saw blade 16 by movement of handle cam 46. When handle cam 46 is in its up position, there is no tension pressure applied to rod fence lock 50, and therefore, no clamping pressure applied to rear rail 36 by locking pawl 44. However, when handle cam 46 is pushed downward by an operator, the camming portion 52 of handle cam 46 provides a tension force to rod fence lock 50. The tension force applied to rod fence lock 50 causes locking pawl 44 to apply a clamping pressure to rear rail 36 and, thus, secures fence assembly 12 in place at a predetermined distance from saw blade 16. Handle cam 46 rotates within annular bearings 48, and therefore, annular bearings 48 provide the wear surface for handle cam 46. The use of the bearings 48 as the wear surfaces is an improvement over prior art fence locking assemblies wherein the wear surface is a plate. The handle cam 46 and annular bearings 48 provide a smoother action and longer life over prior art fence assemblies having a plate as a wear surface.

It is necessary for the operator of the table saw 10 to, at least initially, set the position of fence channel 32 so that it is in parallel alignment to saw blade 16. The preferred embodiment of fence assembly 12 (FIGS. 3-7) comprises a fence channel assembly 32 and a head assembly 42. Fence channel assembly 32 further includes a fence channel 54 and housing 56. Housing 56 includes at least one oversized adjustment hole 58 to receive at least one adjustment screw 66. As shown in FIG. 4, head assembly 42 includes a head 60, which further includes an upwardly extending pin 62. Housing 56 includes a socket 64 to receive pin 62. Alternately, as shown in FIG. 5, pin 62 may downwardly extend from housing 56 and engage socket 64 in head 60. Although in the preferred embodiment, pin 62 extends upward from head 60 and engages socket 64 in housing 56, it is believed that either structural arrangement will accomplish the desired result.

In either embodiment, pin 62 provides at least two important functions: (1) it provides a pivot point for adjustment, and (2) it absorbs shear load that occurs when fence assembly 12 is locked, thereby allowing the operator to lock fence assembly 12 in precise alignment without eliminating the clearance between adjustment holes 58 and adjustment screws 66. This structural configuration allows fence channel 54 to be locked while forcing head 60 firmly against the front side of front rail 34; thus, allowing both fence channel 54 and head 60 to be in precise alignment without binding adjustment screws 66 before they are tightened. Therefore, this structural arrangement allows the operator to tighten adjustment screws 66 to secure alignment of head 60 to fence channel 54 without moving (and possibly misaligning) either fence channel 54 or head 60 during tightening.

The fence assembly of the present invention also combines a self-aligning capability with a lift-off feature. More specifically, head 60 of head assembly 42 has a lower surface 70 and an upper surface 68. Lower surface 70 further includes a rail groove having a predetermined radius. The predetermined radius of the rail groove of lower surface 70 substantially matches the radius of a curved profile portion 72 of front rail 34. The substantially matched radii of the rail groove of lower surface 70 and curved profile portion 72 of front rail 34 allows gravity to “seat” the groove onto the knob portion 72 of front rail 34. The seating of the substantially matched radii causes head assembly 42, and thus, fence assembly 12, to align itself parallel to saw blade 16. This result is accomplished while maintaining the prior art existing structure of lift-off fence assemblies that provide for easy lift-off of the fence assembly from table 20 at any location on surface 22. Additionally, the underside of the rail groove of lower surface 70 preferably includes a material that enhances the sliding engagement of the rail groove with front rail 34.

The fence assembly 12 of the present invention also includes an improved microadjust assembly comprising, in part, a spring-loaded bumper or rubber tip 74 and handle 76. To fine adjust the lateral position of fence assembly 12 with respect to saw blade 16, the operator pushes knob handle 76 to engage rubber tip (bumper) 74 to the underside of front rail 34. The operator then turns knob handle 76 causing rubber tip 74 to rotate. The rotation of rubber tip 74 moves head assembly 42 and fence assembly 12 to move along front rail 34 due to the friction contact between rubber tip 74 and front rail 34. Once the lateral position of fence assembly 12 is finely adjusted, the operator removes pressure from knob handle 76. Release of knob handle 76 causes spring 102 to disengage rubber tip 74 from front rail 34, thereby preventing inadvertent microadjustment of fence assembly 12. While rubber tip 74 is preferably an elastomeric or rubber material, other materials may provide the desired results of a low cost microadjust assembly of which itself does not require adjustment.

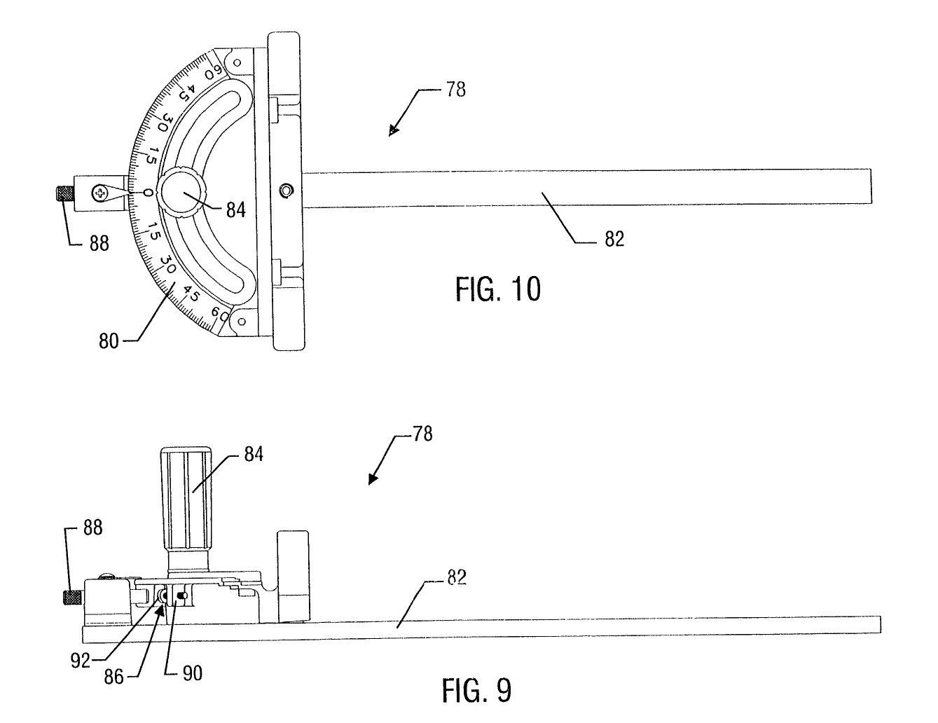

The table saw of the present invention also includes an improved miter gauge assembly 78. The preferred embodiment of the miter gauge assembly 78 of the present invention is shown in FIGS. 8, 9 and 10. FIG. 8 shows the miter gauge assembly 78 in perspective view, while FIGS. 9 and 10 show the miter gauge assembly 78 in side view and top view, respectively. The miter gauge assembly 78 of the present invention includes a gauge 80 pivotly connected to a rod 82. Miter gauge assembly 78 also includes a knob adjustment assembly 84 that, upon tightening (rotation), the knob adjustment assembly 84 secures gauge 80 in a predetermined fixed position with respect to rod 82. The miter gauge assembly 78 further includes at least one adjustable screw stop assembly 86 for providing fine adjustment of gauge 80 at a predetermined angle. The preferred embodiment of miter gauge 80 also includes a pin 88 that engages the adjustable screw stop assembly 86.

Gauge 80 of miter gauge assembly 78 includes at least one downwardly depending gauge extension 90 at a predetermined location on gauge 80. The downwardly depending gauge extension 90 further includes a threaded opening for receiving adjustable screw stop assembly 86. More particularly, adjustable screw stop assembly 86 preferably comprises a screw 92 and a correspondingly fitting nut 94. Preferably, screw 92 has a head end and a second end. The second end of screw 92 extends through nut 94, and then through the opening in downwardly depending gauge extension 90. Thus, the amount of extension of the second end of screw 92 through the opening is controlled by threading screw 92 in the downwardly depending gauge extension 90 and locking it in place with nut 94.

Pin 88 and screw 92 are in substantial vertical alignment such that when pin 88 is slidably extended toward gauge 80, the second end of screw 92 abuts pin 88. Thus, fine adjustment of miter gauge 80 at a predetermined angle is accomplished by controlling the amount of extension of the second end of screw 92 through the opening of gauge extension 90. When pin 88 is in its extended forward position (toward gauge 80), pin 88 acts as a stop for rotation of gauge 80 to a predetermined location. To relocate gauge 80 to a different angle position, the operator simply slides pin 88 to its extended back position. In the extended back position, pin 88 is no longer in the pathway of the adjustable screw stop assembly or assemblies 86. Once gauge 80 is near the next desired location of an adjustable screw stop assembly, the operator simply slides pin 88 to its forward extended position to provide an abutment surface for screw 92.

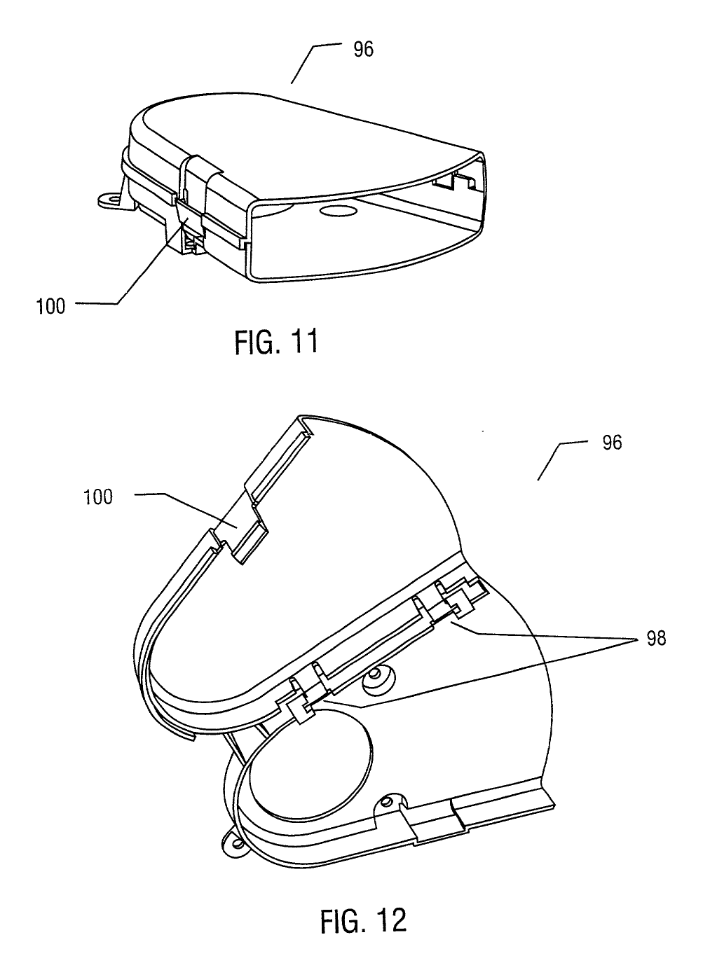

The present invention also includes a hinged belt guard 96 (shown in FIGS. 11 and 12). The belt guard opens substantially in half at a hinge joint 98. The hinged belt guard allows the operator to remove a belt from the electric motor pulley (not shown) without having to completely remove the belt guard. The belt guard may also include an intregally molded latch 100 for securing the guard in a closed position during operation.

What is claimed is:

1. A fence assembly for use on the upper surface of a saw for supporting a workpiece relative to the saw blade of the saw, said fence assembly comprising:
a fence channel having a first end and a second end;
a head assembly operatively connected to said fence channel proximate the first end of said fence channel, said head assembly including a handle cam;
a locking pawl proximate the second end of said fence assembly;
means for operatively connecting said handle cam to said locking pawl such that, when handle cam is rotated, said locking pawl is engaged to secure said fence assembly in a stationary position.

2. The fence assembly of claim 1 further comprising at least one annular ball bearing to rotatably receive and operatively mount said handle cam to said fence channel.

3. The fence assembly of claim 1 wherein said handle cam is of a single piece construction.

4. The fence assembly of claim 3 wherein said handle cam is constructed out of injection-molded plastic.

5. A saw having a fence assembly for supporting a workpiece relative to the saw blade of the saw, said fence assembly comprising:
a fence channel having a first end and a second end;
a head assembly operatively connected to said fence channel; and
means for engaging and locking said fence assembly in a stationary position.

6. The saw of claim 5 wherein said means for engaging and locking said fence assembly in a stationary position comprises a handle cam operatively connected to a locking pawl by a rod fence lock.

7. The saw of claim 6 wherein said handle cam is received and rotatably mounted to said fence channel by at least one annular ball bearing.

8. A fence assembly for use on the upper surface of a saw for supporting a workpiece relative to the saw blade of the saw, said fence assembly comprising:
a fence channel having a first end and a second end, said fence channel including a socket disposed proximate said first end;
a head assembly operatively connected to said fence channel, said head assembly includes a head and a pin extending upwardly from said head, said pin is pivotly disposed in said socket; and
means for engaging and locking said fence assembly in a stationary position.

9. The fence assembly of claim 8 wherein said means for engaging and locking said fence assembly in a stationary position comprises a handle cam operatively connected to a locking pawl by a rod fence lock.

10. The fence assembly of claim 9 wherein said handle cam is received and rotatably mounted to said fence channel by at least one annular ball bearing.

11. The fence assembly of claim 8 wherein said pin absorbs a shear loading of said fence channel against said socket when said fence channel is in a locked position.

12. A fence assembly for use on the upper surface of a saw for supporting a workpiece relative to the saw blade of the saw, said fence assembly comprising:
a fence channel having a first end and a second end, said fence channel including a downwardly extending pin;
a head assembly operatively connected to said fence channel, said head assembly including a head having a socket disposed therein, said socket receives said pin for pivotal rotation; and
means for engaging and locking said fence assembly in a stationary position.

13. The fence assembly of claim 12 wherein said means for engaging and locking said fence assembly in a stationary position comprises a handle cam operatively connected to a locking pawl by a rod fence lock.

14. The fence assembly of claim 13 wherein said handle cam is received and rotatably mounted to said fence channel by at least one annular bearing.

15. The fence assembly of claim 12 wherein said pin absorbs a shear loading of said fence channel against said socket when said fence channel is in a locked position.

16. A fence assembly for use on the upper surface of a saw for supporting a workpiece relative to the saw blade of the saw, and wherein said saw has a front rail with a curved profile portion extending parallel to the length of said front rail, said fence assembly comprising:
a fence channel having a first end and a second end;
a head assembly operatively connected to said fence channel, said head assembly including a head having an upper surface and a lower surface, said lower surface of said head having a groove with a radius substantially matching the radius of said curved profile portion of said front rail; and
means for engaging and locking said fence assembly in a stationary position.

17. The fence assembly of claim 16 wherein said fence assembly can be upwardly removed from upper surface of said saw at any location along said front rail.

18. The fence assembly of claim 16 wherein said means for engaging and locking said fence assembly in a stationary position comprises a handle cam operatively connected to a locking pawl by a rod fence lock.

19. The fence assembly of claim 18 wherein said handle cam is received and rotatably mounted to said fence channel by at least one annular bearing.

20. A fence assembly for use on the upper surface of a saw for supporting a workpiece relative to the saw blade of the saw, and wherein said saw has a front rail extending parallel to the front side of said upper surface of said saw, said fence assembly comprising:
a fence channel having a first end and a second end;
a head assembly operatively connected to said fence channel, said head assembly including a means for substantially self-aligning said fence assembly parallel to said saw blade; and
means for engaging and locking said fence assembly in a stationary position.

21. The fence assembly of claim 20 wherein said fence assembly can be upwardly removed from upper surface of said saw at any location along said front rail.

22. The fence assembly of claim 20 wherein said front rail includes a curved profile portion extending parallel to the length of said front rail and said head assembly includes a lower surface having a groove with a radius substantially matching the radius of said curved profile portion of said front rail.

23. The fence assembly of claim 20 wherein said means for engaging and locking said fence assembly in a stationary position comprises a handle cam operatively connected to a locking pawl by a rod fence lock.

24. A fence assembly for use on the upper surface of a saw for supporting a workpiece relative to the saw blade of the saw, and wherein said saw has a front rail extending parallel to the front of said upper surface of said saw, said fence assembly comprising:
a fence channel having a first end and a second end;
a head assembly operatively connected to said fence channel, said head assembly having a microadjust assembly for fine adjustment of said fence assembly, said microadjust assembly including a knob handle operatively connected to a bumper, said bumper engages said front rail and moves said fence assembly in response to rotation of said knob handle; and
means for engaging and locking said fence assembly in a stationary position.

25. The fence assembly of claim 24 wherein the bumper of said microadjust assembly is made out of an elastomeric material.

26. The fence assembly of claim 24 wherein the microadjust assembly further comprises a spring to disengage said bumper from said front rail when not in use.

27. A fence assembly for use on the upper surface of a saw for supporting a workpiece relative to the saw blade of the saw, and wherein said saw has a front rail extending parallel to the front of said upper surface of said saw, said fence assembly comprising:
a fence channel having a first end and a second end;
a head assembly operatively connected to said fence channel, said head assembly having a means for fine adjusting the distance between said saw blade and said fence channel; and
means for engaging and locking said fence assembly in a stationary position.

28. The fence assembly of claim 27 wherein said means for fine adjusting the distance between said saw blade and said fence channel includes a knob handle connected to a bumper, and further including a spring to disengage said bumper from said front rail when not in use.

29. The fence assembly of claim 27 wherein said means for engaging and locking said fence assembly in a stationary position comprises a handle cam operatively connected to a locking pawl by a rod fence lock.

30. A fence assembly for use on the upper surface of a saw for supporting a workpiece relative to the saw blade of the saw, and wherein said saw has a front rail extending parallel to the front side of said upper surface of said saw, and a rear rail extending parallel to the back side of said upper surface of said saw, said fence assembly comprising:
a fence channel having a first end and a second end; and
a head assembly for engaging and locking said fence assembly in a stationary position, said locking pawl is slidably engaged with said rear rail of said saw.

31. The fence assembly of claim 30 wherein said locking pawl is of a single piece construction allowing it to both slide and lock against said rear rail.

32. A fence assembly for use on the upper surface of a saw for supporting a workpiece relative to the saw blade of the saw, said fence assembly comprising:
a fence channel having a first end and a second end;
means for engaging and locking said fence assembly in a stationary position;
a front rail and rear rail wherein said rails are parallel to the front and back sides of said upper surface of said saw, respectively; and
a locking pawl slidably engaged with said rear rail and having a single-piece construction.

33. A miter gauge assembly for use on a saw, said miter gauge assembly used for the mitering of a workpiece by a saw blade of the saw, said miter gauge assembly comprising:
a gauge pivotally connected to a rod;
a knob adjustment assembly to secure said gauge at a fixed angle with respect to said rod;
at least one adjustable screw stop assembly attached to said gauge, said adjustable screw stop assembly provides fine adjustment of said gauge at a predetermined angle; and
a pin to engage said adjustable screw stop at said predetermined angle.

34. The miter gauge assembly of claim 33 wherein said gauge further comprises at least one downwardly depending gauge extension at a predetermined location on said gauge, said extension having an opening.

35. The miter gauge assembly of claim 34 wherein said adjustable screw stop assembly further comprises a screw and a corresponding nut, said screw having a head end and a second end, said screw threaded through said nut and said opening in said downwardly depending gauge extension, said second end of said screw being in substantial alignment with said pin.

36. The miter gauge assembly of claim 35 wherein said downwardly depending gauge extension is integrally formed as part of the gauge.

37. A miter gauge assembly for use on a saw, said miter gauge assembly used to aid in the mitering of a workpiece by a saw blade of the saw, said miter gauge comprising:
a gauge pivotally connected to a rod, said gauge having at least one downwardly depending extension;
a knob adjustment assembly to secure said gauge at a fixed angle with respect to said rod; and
means for fine adjusting said gauge at a predetermined angle.

38. The miter gauge assembly of claim 37 wherein said means for fine adjusting said gauge comprises a screw and a corresponding nut, said screw having a head end and a second end, said screw extending through said nut and said opening in said downwardly depending gauge extension, said second end of said screw being in substantial alignment with a slidably engageable pin.

39. A miter gauge assembly for use on a saw, said miter gauge assembly used for the mitering of a workpiece by a saw blade of the saw, said miter gauge assembly comprising:
a gauge pivotally connected to a rod;
means for securing said gauge at a fixed angle with respect to said rod; and
means for fine adjusting said gauge at a predetermined angle.

40. The miter gauge assembly of claim 39 wherein said means for securing said gauge at a fixed angle with respect to said rod further comprises a know handle, said knob handle having a threaded end which mates with a threaded opening in said rod.

41. The miter gauge assembly of claim 39 wherein said gauge further comprises at least one downwardly depending gauge extension at a predetermined location on said gauge, said extension having an opening.

42. The miter gauge assembly of claim 41 wherein said means for fine adjusting said gauge at a predetermined angle comprises a screw and a corresponding nut, said screw having a head end and a second end, said screw extending through said nut and said opening in said downwardly depending gauge extension, said second end of said screw being in substantial alignment with a slidably engageable pin.

43. A guard for partially covering a belt, said guard having a hinged joint for opening said guard to access said belt without the need for completely removing said guard.

44. The guard of claim 43 further including an integrally molded latch for securing the guard in a closed position.
